(19) United States
(12) Patent Application Publication
(10) Pub. No.: US 2013/0138818 A1
(43) Pub. Date: May 30, 2013

(54) METHOD FOR ACCESSING AN AUTOMATION SYSTEM AND SYSTEM OPERATING ACCORDING TO THE METHOD

(71) Applicant: Edgar Wolf, Herrenberg (DE)

(72) Inventor: Edgar Wolf, Herrenberg (DE)

(73) Assignee: Siemens Aktiengesellschaft, Munchen (DE)

(21) Appl. No.: 13/481,012

(22) Filed: May 25, 2012

(30) Foreign Application Priority Data
May 26, 2011 (EP) EP11167653

(51) Int. Cl. H04L 29/08

(52) U.S. Cl. CPC H04L 29/08576
USPC 709/227

(57) ABSTRACT

A method and a corresponding system for accessing with a programming device an automation system having at least one automation device, includes the steps of establishing an indirect connection between the programming device and the at least one automation device via a conference server located remote from both the automation system and the programming device, said conference server having access to at least one virtual machine comprising engineering software, transmitting engineering data from the conference server to the at least one automation device in response to operator control actions at the programming device, remotely executing with the programming device via the conference server a virtual machine comprising engineering software, and transmitting via the conference server at least screen dumps of the virtual machine to the programming device.

### CROSS-REFERENCES TO RELATED APPLICATIONS

This application claims the priority of European Patent Application, Serial No. 10 EP 11167653, filed May 26, 2011, pursuant to 35 U.S.C. 119(a)-(d), the content of which is incorporated herein by reference in its entirety as if fully set forth herein.

### BACKGROUND OF THE INVENTION

The present invention relates to a method and a corresponding system for accessing an automation system, e.g. for maintenance, diagnostic and setup purposes, etc., by a programming device or the like.

The following discussion of related art is provided to assist the reader in understanding the advantages of the invention, and is not to be construed as an admission that this related art is prior art to this invention.

Methods of this type for accessing an automation system are known in the art. The access relates to the control software executed by one or more automation devices in the automation system as well as to parameterization and project configuration data of the automation devices encompassed by the automation system. The totality of the control software of an automation system as well as of the respective parameterization and project configuration data is referred to here and in the following as an automation solution for short, since this defines the functionality of the respective automation system and consequently the manner in which said system controls and/or monitors a technical process.

The simplest case of such an access consists in service personnel traveling with a programming device to the location of the automation system, connecting the programming device to an automation device of the automation system, for example to a programmable logic controller or, in the case of a more extensive automation system, to an automation device of said kind or to an automation device acting as a master control station, and in this way connecting to the automation system. An engineering software solution is then launched on the programming device in order to gain access to the respective automation solution. The necessary maintenance or setup activities, for example, can thereupon be performed using the engineering software.

However, service organizations providing services of this type in relation to automation systems are required to make their services available on a worldwide scale. What is involved in terms of content here is to place machines and facilities (automation system) for which possible service agreements have been signed and which are geographically dispersed over a plurality of locations into operation with the aid of engineering software, to troubleshoot problems, and to carry out updates and extensions. This is made more difficult as a result of a close interdependence between the version of the engineering software used in the pilot phase and/or during a setup phase and project configuration data generated during a setup phase. This means that a set of configuration data generated for a project cannot automatically be read or indeed modified with arbitrary versions of an engineering software solution.

Consequently, the service personnel must bring along a version of the engineering software that is compatible with the respective project configuration dataset of the automation system. Failing this, it is possible that no fault analysis or no updating or extension of the automation solution can be performed due to incompatibilities.

For service personnel deployed on a regional or even worldwide scale this means that appropriate preparations must be made for such a deployment. These preparations are associated with investment of time and effort as well as costs. Furthermore the engineering software needs to be developed and distributed by the manufacturer. The software is typically supplied on an installation medium (CD, DVD, etc.). Over the last several years a form of shipment has also become established in which the installation data can be loaded by a device referred to as a web server. Common to both shipment routes, however, is that the engineering software must subsequently be installed by the end customer and the latter requires assistance in performing this operation from the manufacturer or a service organization through support services. An organization and resources must be provided which give rise not just to investment costs but also to fixed costs.

As already outlined in the introduction, it is standard practice in the prior art for service personnel to take with them to the location of the automation system the software and add-on software required for a service assignment or setup project together with the associated project configuration dataset on a portable computer (laptop) serving as a programming device. In such a situation it may be that multiple versions of the setup and engineering software are required on site—dependent on the one hand on the scale of the automation system and/or the respective automation solution and on the other hand on the project history. For the service organizations and their employees this represents a not inconsiderable amount of time and expense in terms of administration and preparation.

In order to avoid or mitigate this problem many service and setup engineers have recently gone over to using virtual machines which are held resident on the hard disk of the programming device in the form of what are termed images. Thus, one or more such virtual machines and engineering software executable thereon are immediately available with the programming device at the site of the respective automation system. The respective virtual machine is started on the programming device and the programming device henceforth acts only as a host computer and as a runtime environment for the respective engineering software.

Admittedly it is also necessary to maintain and update such images of virtual machines or for virtual machines. Backup copies must be taken and the right image must be made available at the right time at the site of the respective automation system. This approach too leads to additional administration overhead and ultimately to costs. Furthermore the accruing volumes of data continue even these days to be a problem, dependent to a very large extent on the project history and on the scale of the automation solution. Often, and more especially when unforeseen service and setup assignments are pending, there is no time or opportunity to take the right engineering software and the associated data along to the site of the respective automation system.

Equally the locations to which service personnel are deployed are frequently at great distances from one another geographically and at the time of an assignment the home base is not always consulted specifically for the purpose of preparing a further service callout. In this situation it is of course useful that thanks to modern broadband communication links it is often possible nowadays to carry out an installation in the sense of an update or upgrade or new installation of software with the support of service personnel from the home base through remote access by the traveling service personnel also while on the move. However, this sometimes constitutes a considerable amount of additional outlay in terms of time and in relation to costs.

Furthermore it is occasionally unfavorable with the prior art approach to performing an relevant access to an automation system that it represents a not inconsiderable amount of time and effort for the service personnel to make the project configuration data available on data media to the respective customer or operator of the automation system, at least at the end of the assignment. However, the operator of the automation system is dependent on this project configuration data in order to have the latest data available at all times and also to have the option of changing to a different service organization if necessary.

An additional factor is that even with the present state of the art it still takes several weeks for the manufacturers of the engineering software to produce installation media and consequently the availability of the engineering software is subject to delay. Once the installation media are available or the engineering software is available online (insofar as this is technically possible), a corresponding infrastructure must be provided by the manufacturer in order to support customers during the installation and configuration of the engineering software. In addition a not inconsiderable amount of time and effort must be expended in order to ensure compliance with regard to a proper use of the engineering software according to the terms of the licensing agreement.

It would therefore be desirable and advantageous to obviate prior art shortcomings and to provide an improved method for accessing an automation system which avoids the above-cited disadvantages or at least reduces their effects.

### SUMMARY OF THE INVENTION

According to one aspect of the present invention, a method accessing with a programming device an automation system having at least one automation device, includes the steps of establishing an indirect connection between the programming device and the at least one automation device via a conference server located remote from both the automation system and the programming device, said conference server having access to at least one virtual machine comprising engineering software, transmitting engineering data from the conference server to the at least one automation device in response to operator control actions at the programming device, remotely executing with the programming device via the conference server a virtual machine comprising engineering software, and transmitting via the conference server at least screen dumps of the virtual machine to the programming device.

The conference server thus has access to data representing such a virtual machine. The site at which the conference server is located is referred to for short in the following as a computing center, though without renunciation of a possibly more far-reaching generality. A computing center of this type may be a server, a cluster of servers known as a server farm or even a distributed server farm of the respective service organization or of a service provider of the service organization. Accordingly, in the approach presented here, the installation site of the engineering and setup software is relocated into a computing center. A plurality of the computing centers which may operate as mutual replacements for one another may be distributed globally. The interconnection of one or more distributed computing centers connected to the Internet is referred to in the following also as a “cloud”. A plurality of versions of an engineering software solution may be held in readiness there, with the result that when service personnel are deployed to the site of an automation system, the version of the engineering software required for the respective automation system and its components may always be made available online.

An image which may be started in a virtual machine by the conference server or indirectly by the programming device may be held in readiness for each version of the engineering software. The conference server may likewise be held in readiness at a computing center or at the same computing center. It establishes the connection between the engineering software running in the computing center, the programming device and the automation system, i.e. at least one automation device of the automation system. This type of connection setup ensures that only authorized users and units, i.e. automation devices on the automation system side, can be connected to one another. A multi-client capability of such a solution is also ensured by the conference server.

The connection between the aforementioned subscribers may be established by way of the communication links and networks (LAN, WLAN, WAN, mobile radio networks, etc.) that can be accessed locally and as a function of the particular situation. A piece of software which establishes the access to and from the conference server and permits the access may be installed on the programming device, in other words in particular on a laptop or some other portable computer of the service and setup engineer, as well as also on the at least one automation device of the automation system by which the communicative connection is set up, or the software is made available in some other suitable manner.

In this scenario, the conference server fulfills at least the following two functions:

Firstly, the conference server establishes a virtual connection between the automation system and the virtualized engineering software running in the computing center or started by the conference server. The connection to the automation system exists to at least one automation device of the automation system. The connection is used to enable communication with the automation device or with each respective automation device. Typically, this entails a form of communication serving to load the project configuration data generated by the engineering software into the automation system. The communication via an engineering protocol may, however, also be used for diagnosing faults or error states or for checking the proper functioning of the automation system and/or its units. The communication may take place over secure or non-secure, i.e. encrypted or unencrypted connections.

Secondly, the conference server establishes a virtual connection between the engineering software and the programming device of the service and setup engineer. The virtual connection serves for transmitting image data and the like to ensure the engineering software may be displayed on the screen at the programming device. Conversely, the virtual connection between programming device and the engineering software running in the computing center may also be used for transmitting various input data to enable the remote engineering software to be controlled by the programming device. This connection is likewise established only virtually by way of the conference server. The connection therefore assists in the transfer of files and/or in desktop sharing. However, it is irrelevant whether in fact individual files are transferred by the programming device or whether the access to the project configuration data of the programming device is made possible in some other way.

The following options exist for making project configuration data available that are required for servicing or for starting up an automation system on-site for startup: Firstly, the project configuration data can be loaded from the programming device to the virtualized engineering software into the computing center over a temporary virtual connection set up by the conference server or an available virtual connection (file transfer). Secondly, a directory or a drive of the programming device can be released for access by a virtual connection set up by the conference server for the virtualized engineering software. The directory or drive can then be used by the engineering software running in the computing center as a quasi-local storage medium for project configuration data. Finally, the project configuration data required for the setup can be uploaded to the conference server and made available automatically to the virtualized engineering software by one of the above-described methods after selection of the automation system.

It is immaterial here whether the conference server is made accessible via the Internet or in some other public network, or whether the conference server is installed in the network of a corporation or private organization (the technical literature distinguishes between the two applications with the terms “private cloud” and “public cloud”). What matters is the combination of computing center application with the technology of the conference server, while the direction of the connection setup (i.e. from the automation system to the conference server on the one hand and from the programming device to the conference server on the other) is also not important. In corporate networks or even when public networks are involved, a connection may advantageously be set up from the automation system to the conference server, on the one hand, and from the programming device to the conference server, on the other hand.

It is likewise immaterial whether the conference server and the virtual machine having the engineering software are operated at the same computing center or on a geographically distributed, possibly global, basis. In the latter case, after the startup of the respective virtual machine, a connection is set up between the virtual machine and the conference server, with the direction of the connection setup, i.e. either originating from the conference server or originating from the virtual machine, being arbitrary.

A portable or permanently installed computer or the like can be used as a programming device. What is important is that the programming device permits the execution of software that the service and setup engineer requires or uses in order to complete his/her tasks. This software can be part of the operating system of the programming device or it can be loaded subsequently into a memory of the programming device.

With the invention, the previously required amount of time and effort, as outlined in the introduction, can advantageously be eliminated due to the shared access to the project configuration data stored in the computing center.

Since a communicative connection exists between the programming device and the conference server, on the one hand, and the conference server and the at least one automation device, on the other hand, an indirect communicative connection is established between the programming device and the at least one automation device of the automation system that is to undergo maintenance, diagnostics or setup. The communicative connection between programming device and conference server as well as conference server and automation device does not have to be permanent; rather, the connection may only exist when data traffic is present. The connections are therefore also referred to as virtual connections.

Because a further communicative connection exists between the conference server and one or more devices having a database for at least one virtual machine having engineering software, the conference server can act as intermediary between the programming device and the engineering software on the one hand and between the automation device in the automation system and the engineering software on the other hand. For the operator of the programming device, control actions carried out by an operator at the programming device may execute the remote engineering software, with outputs from the engineering software being transmitted to the programming device to then be checked by the operator. Project configuration data or other engineering data can be transmitted directly by the engineering software to the automation system and there to the at least one automation device by the connection existing by way of the conference server. When the storage location of such project configuration data or engineering data when the automation system is being accessed is a location on the programming device, then the relevant data is transmitted from the programming device to the automation system over the indirect communicative connection of programming device and automation system existing by way of the conference server.

When the engineering software is made available redundantly by a plurality of virtual machines, simultaneous access to a virtual machine having respective engineering software is possible in each case by a plurality of service and setup engineers.

When the plurality of redundant virtual machines is made available on a distributed basis over multiple locations, additional security relating to the storage of data resources on the virtual machines is required. Even an incident leading to damage in a computing center and a possible loss of one or more virtual machines as a consequence thereof permits the continuing availability of the services provided by the service organization. Furthermore, given a geographically distributed availability of such virtual machines having engineering software, the service personnel can in each case choose the geographically most favorably located computing center comprising the virtual machine or machines disposed there, such that an improved data throughput will potentially be achieved and consequently it will be possible to work at a faster rate.

When the geographically distributed availability of redundant virtual machines, each having engineering software, is ensured automatically, a data backup scheme affording sufficient loading capacity is produced. Even if one computing center crashes, its data can be fully restored at any time by subsequent transfer of the virtual machines from other computing centers.

According to another aspect of the invention, a system constructed to carry out the method includes a programming device, an automation system with at least one automation device, a conference server, and at least one virtual machine having engineering software. A first virtual connection is established between the programming device and the conference server, a second virtual connection is established between the at least one automation device and the conference server, with the first and second virtual connection together providing a first indirect connection between the programming device and the at least one automation device. A third virtual connection is established between the conference server and the at least one virtual machine, wherein the first and third virtual connection together provide a second indirect connection between the programming device and the at least one virtual machine and wherein the second and third virtual connection together provide a third indirect connection between the at least one automation device and the at least one virtual machine. The first indirect connection is configured to transmit engineering data in response to operator control actions at the programming device. The second indirect connection is configured to allow the programming device to remotely execute at least one virtual machine and at least transmission of screen dumps from the at least one virtual machine to the programming device.

The invention also relates to a computer program with program code instructions that are executable by a computer, and to a storage medium containing a computer program of this type, as well as a processing unit with a microprocessor or the like having a memory into computer program is or can be loaded for carrying out the method.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 shows an automation system according to the present invention, with at least one automation device which can be indirectly accessed with a programming device for maintenance or similar purposes via a conference server, and

FIG. 2 shows a separate view of individual connections when accessing the automation system according to FIG. 1.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

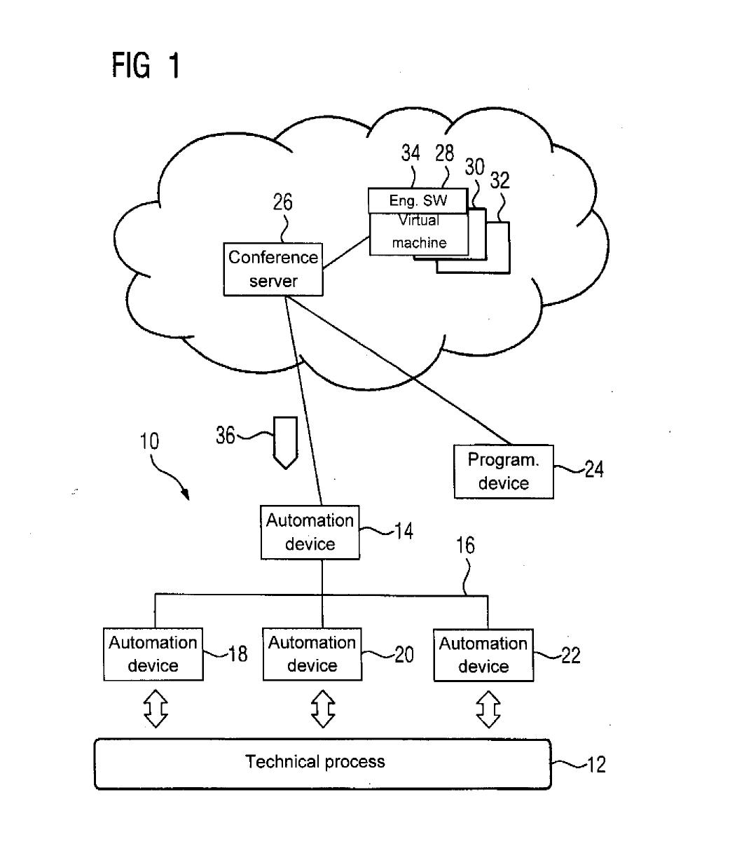

Turning now to the drawing, and in particular to FIG. 1, there is shown a schematically simplified diagram of an automation system 10 for controlling and/or monitoring a technical process 12 (not depicted in detail). The automation system 10 comprises at least one automation device 14. The terms automation system 10 and automation device 14 are sometimes used synonymously. In the situation shown the automation system 10 comprises a plurality of automation devices 14, 18, 20, 22 communicatively connected via a bus 16 for example. For the purpose of controlling and/or monitoring the respective technical process 12 for the automation system 10, namely by the automation device or by each automation device 14, 18-22 encompassed thereby, one or more control programs (not shown) are executed in a per se known manner. The totality of the control programs and a configuration and/or parameterization of the individual automation devices 14, 18-22, such as drives and the like, are referred to in the following as an automation solution.

The automation system 10 is to be accessed by service personnel or personnel of the operator of the automation system 10 by a programming device 24 for e.g. maintenance, diagnostic and setup purposes, etc. In the prior art a direct communicative connection, originating from the programming device 24, to at least one automation device 14, 18-22 of the automation system 10 was established for that purpose. However, this also requires the availability, on the programming device 24, of an engineering software version which is compatible with the automation system 10 and the automation solution executed thereon. In order to avoid the problems attendant thereon it is provided that only an indirect connection to the automation system 10 is established.

Said indirect connection is set up by way of a conference server 26. In order to access the automation system 10 by the programming device 24 there accordingly exists an indirect connection between the programming device 24 and at least one automation device 14 encompassed by the automation system 10, and specifically by way of the conference server 26 which is spatially remote from the automation system 10 and from the location of the programming device 24. The conference server 26 has access to at least one virtual machine 28, 30, 32 having engineering software 34. A computing center, for example a computing center of a service organization, may be considered suitable as the location for the conference server 26 and the at least one virtual machine 28, 30, 32. The location of the conference server 26 and the at least one virtual machine 28, 30, 32 is also referred to as a “cloud” and is accordingly drawn as a cloud in the illustration in FIG. 1. In this scheme the physical location of a computer on which the conference server 26 is executed as a software application and of one or more computers on which one or more virtual machines 28-32 can be executed, can by all means fragment and the “cloud” is as it were a virtual location. A simple “cloud” comprises only one computer which executes the conference server 26 and the virtual machine or each virtual machine 28-32.

The conference server 26 permits the remote execution of the virtual machine 28 and the resident engineering software 34 by the programming device 24. The conference server 26 transmits at least screen dumps of the respective virtual machine 28-32 or the respective engineering software 34 to the programming device 24 and operator control actions performed at the programming device 24 to the virtual machines 28-32 and their engineering software 34. Engineering or project configuration data 36 is also transmitted to the at least one automation device 14 by the conference server 26 and as a function of operator control actions at the programming device 24. the engineering or project configuration data 36 is generated within the scope of the remote control of the engineering software 34 by the programming device 24 and as a result of the changing, updating or modification of the automation solution executed by the automation system 10 that is possible by the engineering software 34.

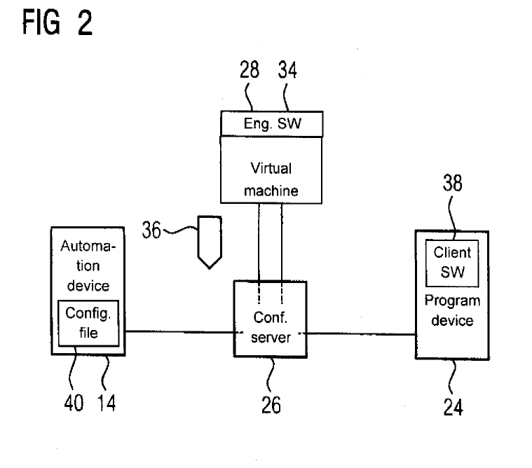

FIG. 2 shows individual aspects of the situation according to FIG. 1 in a once again further schematically simplified view in order to clarify the connections existing for accessing the automation system 10 (FIG. 1) and at least one automation device 14 there. The connections existing from the programming device 24 to the virtual machine 28 and its engineering software 34 by way of the conference server 26 are for example so-called VNC connections (VNC=Virtual Network Computing) and accordingly permit the execution of the engineering software 34 on the remote virtual machine 28 by the programming device 24. The connections existing between the virtual machine 28 and its engineering software 34 and the automation device 14 are for example connections which permit the use of an engineering protocol, for example the so-called S7 protocol of the applicant, and transmissions of files (file transfer). It is furthermore apparent that the connection from the programming device 24 to the at least one automation device 14 in the automation system 10 exists only indirectly, and specifically by way of the conference server 26, in that the latter provides connections to the virtual machine 28 and its engineering software 34.

The engineering software 34 is preconfigured in all available versions or at least in certain major versions and provided by the conference server 26 in a virtual machine 28-32 according to requirements and then instantiated as befits the particular situation. There thus exists the possibility for the service personnel to set up a connection to the virtual machine 28-32 instantiated in the computing center by way of the conference server with the aid of client software 38 installed on the programming device. This enables the virtual machine 28-32 to be controlled and used remotely. In addition a connection for transmitting files (file transfer) to the virtual machine 28-32 is set up by the conference server 26 and the project configuration data (configuration file 40) required for the automation system 10 is made available. As soon as the configuration file 40 has been loaded by the engineering software 34 executing on the respective virtual machine 28-32, a virtual connection can again be set up between the respective virtual machine 28-32 and the at least one automation device 14 of the automation system 10 by way of the conference server 26. As a result the project configuration data can be uploaded to the conference server 26, for example at the latest following completion of the service assignment, from the respective virtual machine 28-32 with the aid of the engineering software 34 which communicates with the conference server 26 via an engineering protocol. The project configuration data can be transferred to the automation system 10 by way of the conference server 26 as switching point. For that purpose a connection suitable for use of the engineering protocol is also set up between the conference server 26 and the at least one automation device 14 of the automation system. Said connection is sufficient in the form of a virtual, i.e. not necessarily permanently existing, connection.

A diagnosis of the automation system 10 or individual automation devices 14, 18-22 encompassed thereby is also possible according to the same principle. The conference server 26 can maintain all the project configuration data of a service organization in reserve so that said data is available at any time and for any authorized employee.

Individual aspects in the forefront of the description submitted here can therefore be briefly summarized as follows: A method for accessing an automation system 10 is disclosed which is based on a combination of existing Internet and network technology, as well as network access technology, computing center application and a conference server 26 that is available in a network, for example on the internet. In order to access the conference server 26, a piece of client software 38 is launched on a programming device 24. A similar software functionality executes on the at least one automation device 14 of the automation system 10 by way of which the access to the automation system 10 is realized. Virtual, i.e. not necessarily permanently existing, communication links are set up between the individual units of the system (subsystems), namely programming device 24, conference server 26 and automation device 14, as well as the conference server 26 and at least one virtual machine 28-32. Each communication link between every two subsystems is only required to exist when data traffic is also being handled by way of the respective connection. By the described combination of subsystems and the type of connection between the subsystems there is produced an overall system having capabilities and advantages that did not exist in the prior art.

The advantages are in particular lower organization, preparation and fixed costs for users and manufacturers of the engineering software 34. The manufacturer of the engineering software has lower costs because the previously necessary investment of resources and the costs associated therewith for the production of the installation media can be saved. Furthermore, no support needs to be given for the installation of the engineering software, since said installation is carried out once only in a central computing center and is then available for an instantiation on virtual machines 28-32. Only a piece of client software 38 enabling access to the conference server or a conference server 26 is required on a programming device 24 that is used by the service personnel. The client software 38 is independent of the respective engineering software 34 and therefore permits the remote use also of future versions of the engineering software 34. The corresponding client software on the side of the automation system 10 can be installed or made available at the time of shipment of the automation system 10.

A multiplicity of advantages is likewise produced for the operator of the automation system 10 and for service organizations, as well as for service personnel employed there in each case. On the one hand the effort involved in the previously sometimes necessary installation of engineering software 34 is eliminated, since said software is permanently available online and the service personnel can access same spontaneously by a correspondingly equipped (with client software 38) programming device 24. As a result the user saves time, investment of labor and resources, and consequently, in the final analysis, costs. On the other hand the response time for service assignments is reduced. The service personnel can respond more rapidly and ultimately achieve a higher throughput. The engineering software 34 is independent of the respective location of the service personnel and available on demand and worldwide. The only requirement is the presence of appropriate access networks.

All in all, the solution based on the method described here for accessing an automation system can also be obtained as a service (“public cloud”) or made available by way of a licensing agreement (“private cloud”). In the case of its use as a service there is a low investment threshold which nonetheless holds open the possibility of scaling. When desired, customers of such a service can benefit from secure storage of data, i.e. in particular engineering and project configuration data, and from automatic assignment and provision of the respective data. All data is available in equal measure to the service organization and to the operator of the respective automation system 10. Practically no overhead is incurred for the service organization and for the operator in respect of backup and handling, as well as archiving of the copies of the project files. The guarantee of the availability of such data over the entire lifecycle of the respective automation system 10 is associated with negligibly low costs in comparison with the previous situation. Finally, a migration of a legacy resource of old project configuration data can be performed easily and in an almost cost-neutral manner, namely by uploading the project configuration data into the “cloud”.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

1. A method for accessing with a programming device an automation system having at least one automation device, said method comprising:
establishing an indirect connection between the programming device and the at least one automation device via a conference server located remote from both the automation system and the programming device, said conference server having access to at least one virtual machine comprising engineering software,
transmitting engineering data from the conference server to the at least one automation device in response to operator control actions at the programming device,
remotely executing with the programming device via the conference server a virtual machine comprising engineering software, and
transmitting via the conference server at least screen dumps of the virtual machine to the programming device.

2. The method of claim 1, wherein the programming device is connected for communication with the conference server and the conference server is connected for communication with the at least one automation device.

3. The method of claim 2, wherein the conference server is connected for communication with one or more additional devices, with each additional device comprising a database for at least one virtual machine.

4. The method of claim 1, wherein the engineering software is provided by a plurality of redundant virtual machines.

5. The method of claim 4, wherein the plurality of redundant virtual machines is geographically distributed.

6. The method of claim 5, wherein availability of the geographically distributed redundant virtual machines is automatically provided by the engineering software.

7. A system, comprising:
a programming device,
an automation system with at least one automation device,
a conference server, and
at least one virtual machine having engineering software,
a first virtual connection between the programming device and the conference server,
a second virtual connection between the at least one automation device and the conference server, with the first and second virtual connection together providing a first indirect connection between the programming device and the at least one automation device,
a third virtual connection between the conference server and the at least one virtual machine, wherein the first and third virtual connection together provide a second indirect connection between the programming device and the at least one virtual machine and wherein the second and third virtual connection together provide a third indirect connection between the at least one automation device and the at least one virtual machine,
wherein the first indirect connection is configured to transmit engineering data in response to operator control actions at the programming device, and
wherein the second indirect connection is configured to allow the programming device to remotely execute at least one virtual machine and at least transmission of screen dumps from the at least one virtual machine to the programming device.

8. A computer program comprising program code embodied on a non-transitory storage medium, wherein the program code, when loaded into memory of a device selected from programming device, conference server and automation device and executed on the device, causes the device to perform the steps of:
establishing an indirect connection between the programming device and the at least one automation device via a conference server located remote from both the automation system and the programming device, said conference server having access to at least one virtual machine comprising engineering software,
transmitting engineering data from the conference server to the at least one automation device in response to operator control actions at the programming device,
remotely executing with the programming device via the conference server a virtual machine comprising engineering software, and
transmitting via the conference server at least screen dumps of the virtual machine to the programming device.

9. A computer program product comprising program code which are stored on a non-transitory computer-readable data medium, wherein the program code, when loaded into memory of a device selected from programming device, conference server and automation device and executed on the device, causes the device to perform the steps of:
establishing an indirect connection between the programming device and the at least one automation device via a conference server located remote from both the automation system and the programming device, said conference server having access to at least one virtual machine comprising engineering software,
transmitting engineering data from the conference server to the at least one automation device in response to operator control actions at the programming device,
remotely executing with the programming device via the conference server a virtual machine comprising engineering software, and
transmitting via the conference server at least screen dumps of the virtual machine to the programming device.

10. In combination,
a digital storage medium having electronically readable control signals, and
at least one member selected from the group consisting of a processing unit of a programming device, a conference server, and an automation device,
wherein the control signals interact with the member to execute a method as set forth in claim 1.
